(19) United States
(12) Patent Application Publication
(10) Pub. No.: US 2010/0009318 A1
(43) Pub. Date: Jan. 14, 2010

(54) DEVICE FOR ATTACHING DENTAL MODEL TO ARTICULATOR

(76) Inventor: Byung Geun Kim, Busan (KR)

Correspondence Address: THE NATH LAW GROUP, 112 South West Street, Alexandria, VA, 22314, US

(21) Appl. No.: 11/991,377

(22) PCT Filed: Aug. 11, 2006
(86) PCT No.: PCT/KR2006/003163

§ 371 Date: Sep. 11, 2009

(30) Foreign Application Priority Data
Sep. 8, 2005 (KR) 10-2005-0083469

(51) Int. Cl. A61C 11/08

(52) U.S. Cl. 433/213

(57) ABSTRACT

The present invention relates to a device for attaching a dental model to a variety of articulators for reproducing oral motions as a sagittal plane of a patient's organism and the left and right side points having the same height relative to the sagittal plane are found to mount the dental model at the articulators in a range for reproducing fatigue oral motions thereon, thereby helping the fabrication of the dental prosthesis inclusive of clinical treatment planning according to the extrusion and intrusion causes, the reasonable articulation re-construction in a dental laboratory process, and artificial teeth arrangements.

### TECHNICAL FIELD

The present invention relates to a device for attaching a dental model to an articulator, and more particularly, to a device for attaching a dental model to a variety of articulators for reproducing oral motions as a sagittal plane of a patient's organism and the left and right side points having the same height relative to the sagittal plane are found to mount the dental model at the articulators in a range for reproducing fatigue oral motions thereon, thereby helping the fabrication of the dental prosthesis inclusive of clinical treatment planning according to the extrusion and intrusion causes, the reasonable articulation re-construction in a dental laboratory process, and artificial teeth arrangements.

### BACKGROUND ART

Many kinds of articulators are developed in order to reproduce oral motions, which are divided into mean value adjustable ones, half adjustable ones, and full adjustable ones. They have the upper and lower frame members having a distance in a range between 98 mm and 108 mm with respect to each other, and general methods for attaching a dental model to the articulators adopt a shilla system, a nano system, and a face bow.

The shilla system is developed on a basis of concept that a human body is divided symmetrically into left and right sides on his structure, shape, and weight relative to a median sagittal plane under the impact of earth's gravity. Thus, there exist median sagittal plane components and left and right horizontal components relative to the median sagittal plane components on a maxillary model, and based thereon, the median sagittal plane and the optimal left and right side points having the same height in the horizontal components are found and positioned to the articulator, thereby performing functional and beautiful prosthetic fabrication according to the horizontal diagnosis and treatment plans relative to the extrusion and intrusion causes.

According to the shilla system, a needle disposed at a sagittal plane of a first shilla instrument is positioned in the middle portion of the incisive papillae appearing at the median sagittal plane components (median palatal raphe, incisive papillae, and upper labial frenum), and another needle is positioned at the medial palatal raphe.

And, two left and right needles are moved by the same distances at the optimal left and right side points having the same height relative to the median sagittal plane, while having the same lengths as each other, before the dental model is moved and positioned thereon.

Thus, the dental model having the left and right side points having the same height relative to the median sagittal plane is positioned, and after that, in order to move the left and right side points to a second shilla instrument, the left and right side points having the same height should be transferred to a hamula notch.

At this state, left and right pins are placed on the hamula notch, and in order to make the two pins formed at the same height, a notch of 0.5 mm is formed at the long pin and the pin shorter than the long pin is formed at the same height as the notch opposing thereto.

As a result, the optimal left and right side points having the same height appearing on the palatal horizontal plane are transferred to the hamula notch, and in case of an edentulous jaw, the median sagittal plane and the left and right side points having the same height that are obtained through the first shilla instrument by using the second shilla instrument are made in such a manner as to place a bar of 7 mm at the hamula notch for the height of posterior and to adjust the needle placed at the incisive papillae at height through the movement of a screw for the height of anterior when a distance of 22 mm exists between a border and the end portion of the central incisor.

On the other hand, in a case where premature contact is made on a plane plate through the extruded teeth by the remaining natural teeth, a bar of 12 mm is disposed for the height of posterior and the needle is moved upwardly by 5 mm for the height of anterior, thereby positioning the dental model thereon (See on pages 49 through 56 and pages 72 through 80 of a book entitled ‘Utilization of shilla system according to dentulous and edentulous jaws cases’ written by Sinhyung International Co. Ltd.).

The shilla system as mentioned above has lots of advantages upon application in the above-described manner, but there occur some problems that the attaching process is complicate to cause lots of time delay and errors. Further, the extrusion and intrusion causes can be found when the dental model is placed on the plane plate of the second shilla instrument just through the analysis on the first shilla instrument, and upon setting the height of the posterior, only two heights can be set by using the bars of 7 mm and 12 mm. The left and right needles to be placed on the plane plate of the first shilla instrument with respect to the water bottle-like left and right side points having the same height relative to the median sagittal plane, around the median palatal raphe that is not transformed in 12 years to 13 years after the extraction of the posterior, start to be diagnosed out of the range of 10 mm from the median sagittal plane, which is caused by the structural defects thereof. In case of analyzing the dental model again, also, there occurs a problem that a plaster dental model is made again on the notches appearing on the hamula notch.

Additionally, even though the dental model is perfect with no external damage or pressure thereagainst through best analyzed results, it may be different when compared with the sagittal plane observed through a patient's organism, which makes it difficult to accept and correct the differences between them. Therefore, there is a need for improvements of the device for attaching a dental model to an articulator.

### DISCLOSURE OF INVENTION

### Technical Problem

Accordingly, it is an object of the present invention to provide a device for attaching a dental model to a variety of articulators for reproducing oral motions as a sagittal plane of a patient's organism and the left and right side points having the same height relative to the sagittal plane are found to mount the dental model at the articulators in a range for reproducing fatigue oral motions thereon, thereby helping the fabrication of the dental prosthesis inclusive of clinical treatment planning according to the extrusion and intrusion causes, the reasonable articulation re-construction in a dental laboratory process, and artificial teeth arrangements.

### Technical Solution

To achieve the above object, there is provided a device for attaching a dental model to an articulator that includes: a base frame having an ascending hole formed in the middle portion thereof such that the device for attaching the dental model is adjusted upwardly and downwardly at height through the ascending hole; a dental model attaching stand having a fixed bracket fixedly formed at the bottom portion thereof, the fixed bracket having an ascending protrusion formed at the bottom surface thereof in such a manner as to be adjusted at height by means of an adjusting bolt formed on one side of the base frame, and having an adjusting bracket formed on the fixed bracket in such a manner as to be adjusted at angle by means of a screw-type adjusting shaft pin, the adjusting bracket having a sliding opening formed on one side thereof; a left and right slider adapted to be guided through guide grooves thereof to the sliding opening in such a manner as to be adjusted in left and right sides by means of an adjusting bolt screw-coupled to the adjusting bracket; an upper and lower slider connected to the top side of a screw-type adjusting member coupled to a female screw hole formed on the left and right slider; a first ascending needle coupled to a female screw hole formed on the screw-type adjusting member in such a manner as to be adjusted upwardly and downwardly at height thereof; a plurality of forward and backward sliders formed on both sides of the upper and lower slider and coupled on both ends of a forward and backward adjusting screw portion having left and right screws and an adjusting knob thereon in such a manner as to be adjusted in forward and backward directions thereof; a second ascending needle fixed on the forward and backward sliders, respectively; a third ascending needle screw-coupled to a female screw hole formed on the other side of the adjusting bracket in such a manner as to be adjusted at height thereof; an adjusting bracket formed at the end portion of one side of the adjusting bracket in such a manner as to be adjusted at angle by means of an adjusting shaft pin; an adjusting piece formed at the top end of the adjusting bracket in such a manner as to be adjusted at angle by means of an adjusting shaft pin; a fourth adjusting needle coupled to an adjusting hole formed on the adjusting piece in such a manner as to be fixed by means of a fixing bolt; a level mounted on one side of the adjusting bracket; a first protractor mounted on one side of the adjusting bracket for measuring an angle upon mounting the device for attaching the dental model to the articulator; and a second protractor mounted at a rotary portion of the adjusting shaft pin with respect to the adjusting bracket.

Generally, when the sagittal plane is viewed at the side thereof, it is of a ‘□’-like shape made by coupling two ‘□’?like shapes to each other. This means the sagittal plane can be found in the ‘□’?like shape.

According to the present invention, there is provided the device for attaching the dental model to the articulator wherein so as to find the sagittal plane, the dental model attaching stand having the first and third ascending needles arranged in one linear line, the plurality of second ascending needles fixedly mounted at the back and forth sides of the first ascending needle, and a fourth adjusting needle mounted in one linear line with respect to the first and third ascending needles in such a manner as to be adjusted at angle thereof, is mounted on the base frame in such a manner as to be adjusted at angle and height, whereby a sagittal plane of a patient's organism and the left and right side points having the same height relative to the sagittal plane are found to mount the dental model at the articulator in a range for reproducing fatigue oral motions thereon, thereby helping the fabrication of the dental prosthesis inclusive of clinical treatment planning according to the extrusion and intrusion causes, the reasonable articulation re-construction in a dental laboratory process, and artificial teeth arrangements.

### BRIEF DESCRIPTION OF THE DRAWINGS

FIG. 1 is a perspective view showing a device for attaching a dental model to an articulator according to the present invention;

FIG. 2 is a front view showing the device for attaching a dental model to an articulator according to the present invention;

FIG. 3 is an exploded perspective view showing the dental model attaching stand separated from the device of this invention;

FIG. 4 is a sectional view showing the assembling state of the device for attaching a dental model to an articulator according to the present invention;

FIG. 5 is a partly exploded perspective view showing the dental model attaching stand of the device of this invention;

FIG. 6 is a plane view showing the device for attaching a dental model to an articulator according to the present invention;

FIG. 7 is a sectional view taken along the line A-A of FIG. 6;

FIG. 8 is a front view showing a process of mounting the device of this invention to an articulator to conduct articulation;

FIG. 9 is a perspective view showing the device of this invention having a part additionally included therein; and

FIG. 10 is a sectional view showing a state where the dental model is mounted by the device of this invention having a part additionally included therein.

### MODE FOR THE INVENTION

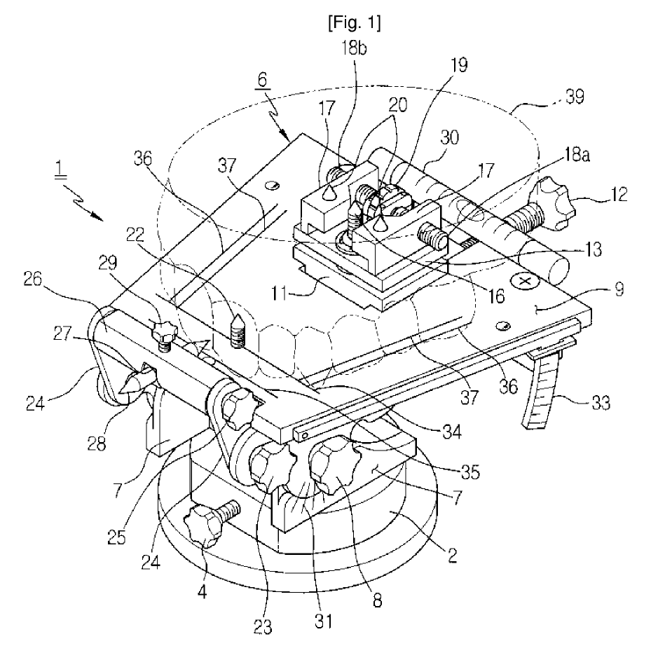

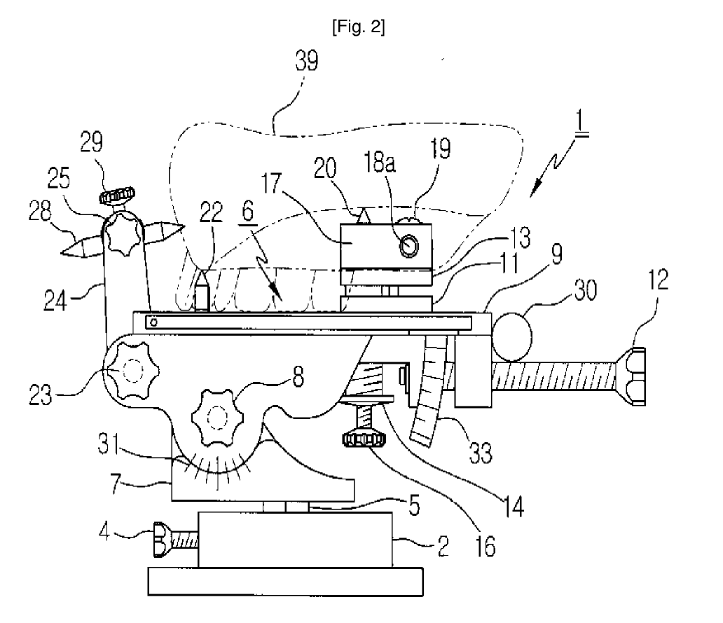

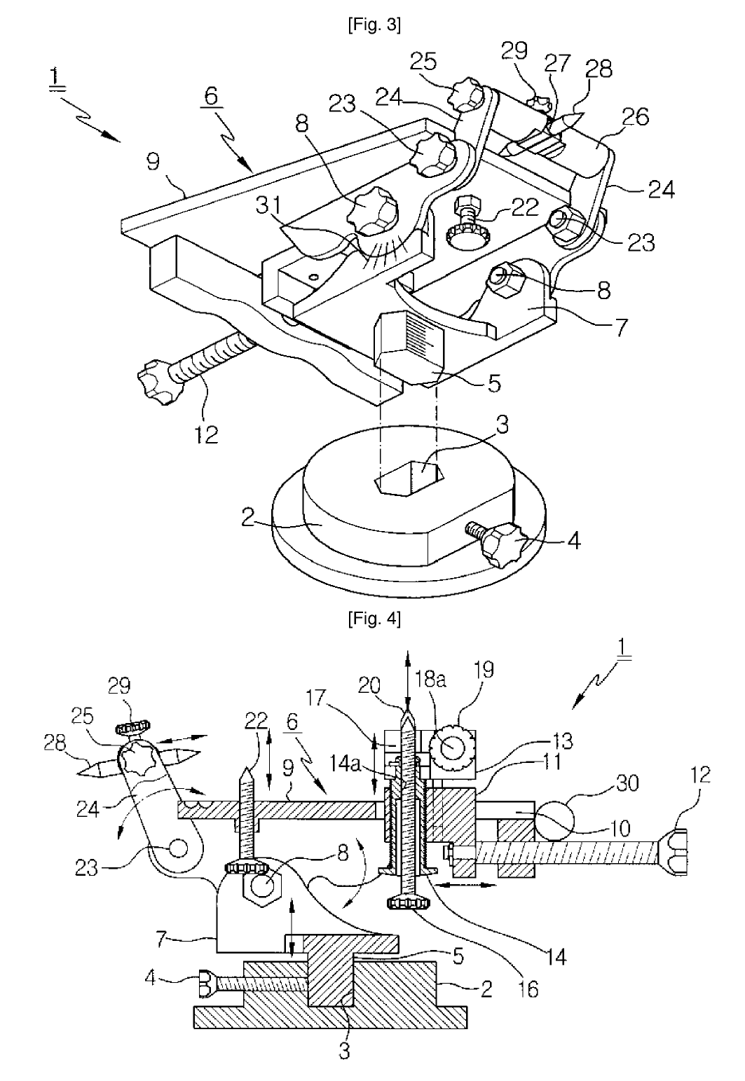

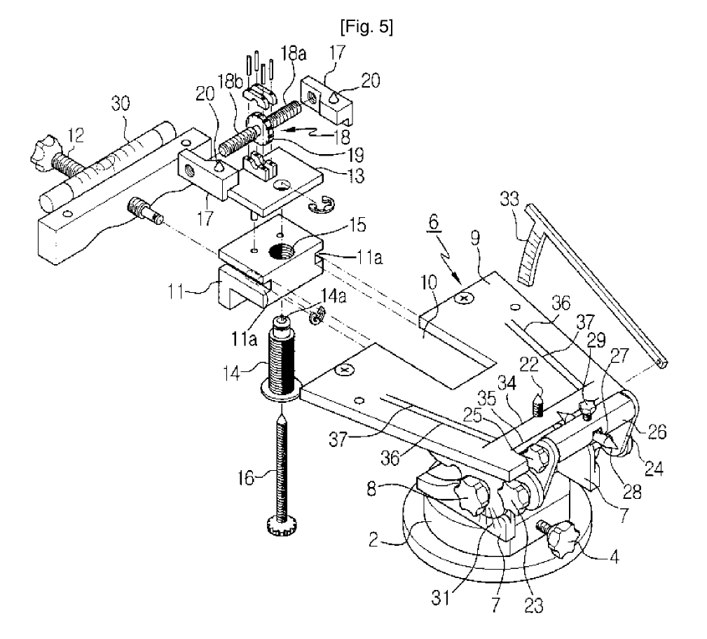

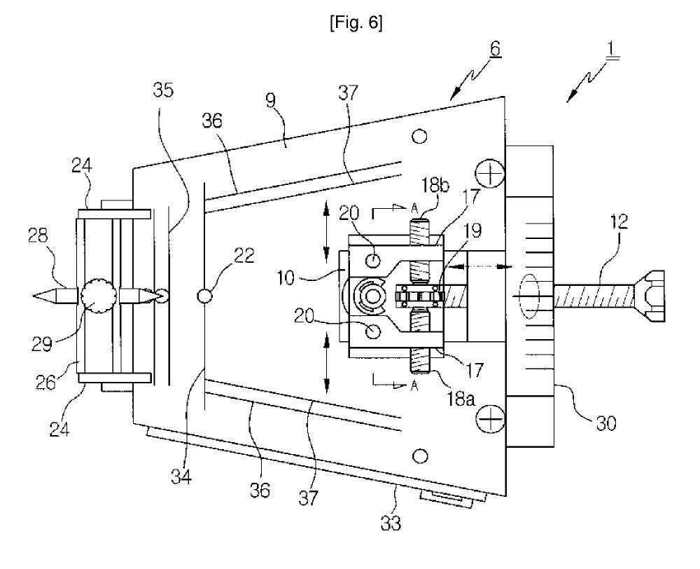

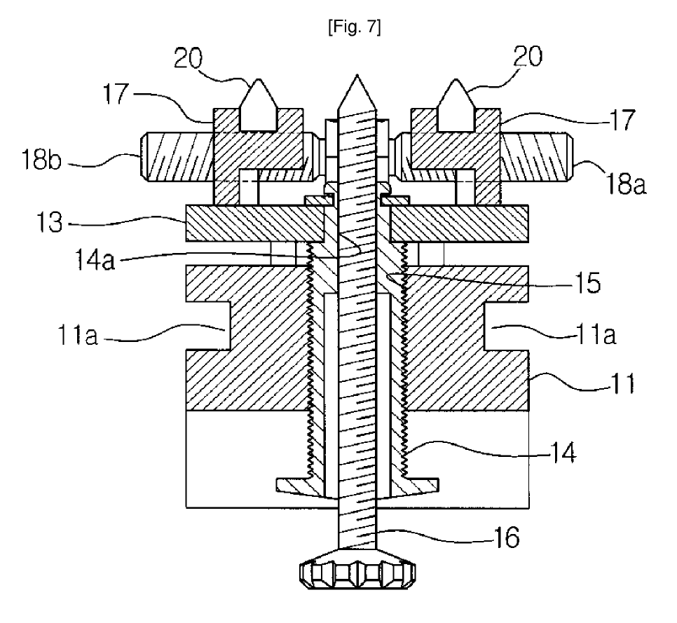

FIG. 1 is a perspective view showing a device for attaching a dental model to an articulator according to the present invention, FIG. 2 is a front view showing the device for attaching a dental model to an articulator according to the present invention, FIG. 3 is an exploded perspective view showing the dental model attaching stand separated from the device of this invention, and FIG. 4 is a sectional view showing the assembling state of the device for attaching a dental model to an articulator according to the present invention. Now, an explanation of the device for attaching a dental model to an articulator according to a preferred embodiment of the present invention will be given with reference to the accompanying drawing.

According to the present invention, a device 1 for attaching a dental model to an articulator has a base frame 2 having an ascending hole 3 formed in the middle portion thereof such that the device 1 for attaching the dental model is adjusted upwardly and downwardly at height through the ascending hole 3. A dental model attaching stand 6 has an ascending protrusion 5 secured at the bottom portion thereof in such a manner as to be adjusted at height along the ascending hole 3 by means of an adjusting bolt 4 formed on one side of the base frame 2.

The dental model attaching stand 6 includes a fixed bracket 7 fixedly formed at the bottom portion thereof, the fixed bracket 7 having the ascending protrusion 5 formed at the bottom surface thereof in such a manner as to be adjusted at height by means of the adjusting bolt 4, and an adjusting bracket 9 formed on the fixed bracket 7 in such a manner as to be adjusted at angle by means of a screw-type adjusting shaft pin 8.

Further, a sliding opening 10 is formed on one side of the adjusting bracket 9, and a left and right slider 11 is adapted to be guided through guide grooves 11a inside the sliding opening 10 in such a manner as to be adjusted in left and right sides. In this case, the left and right slider 11 can be slid in left and right directions by means of forward and backward screw adjustment of an adjusting bolt 12 screw-coupled to the adjusting bracket 9.

Also, an upper and lower slider 13 is mounted on the top portion of the left and right slider 11 by means of a screw-type adjusting member 14. The screw-type adjusting member 14 is assembled to a female screw hole 15 formed in upward and downward directions on the left and right slider 11 in such a manner as to be adjusted upwardly and downwardly at height thereof.

Then, a first ascending needle 16 is coupled to a female screw hole 14a on the screw-type adjusting member 14 in such a manner as to be adjusted upwardly and downwardly at height thereof.

A plurality of forward and backward sliders 17 are formed on one side of the upper and lower slider 13 in such a manner as to be adjusted forwardly and backwardly by means of a forward and backward adjusting screw portion 18 having left and right screws 18a and 18b, and the forward and backward adjusting screw portion 18 has an adjusting knob 19 formed integrally in the middle portion thereof. A second ascending needle 20 is fixedly mounted on each of the forward and backward sliders 17.

On the other hand, a third ascending needle 22 is screw-coupled to a female screw hole 21 formed in upward and downward directions on the other side of the adjusting bracket 9 in such a manner as to be adjusted at height thereof.

Also, an adjusting bracket 24 is mounted at the end portion of the left side of the first adjusting bracket 9 in the drawings in such a manner as to be adjusted at angle by means of an adjusting shaft pin 23, and an adjusting piece 26 is mounted at the top end of the adjusting bracket 24 in such a manner as to be adjusted at angle by means of an adjusting shaft pin 25.

A fourth adjusting needle 28 is coupled to an adjusting hole 27 passed through the adjusting piece 26 in such a manner as to be fixed by means of a fixing bolt 29.

On the other hand, a level 30 is mounted on one side of the adjusting bracket 9 constituting the dental model attaching stand 6 for checking front and back leveling degrees, and a protractor 31 is mounted at the outer periphery of a rotary portion of the adjusting shaft pin 8 with respect to the adjusting bracket 9 for checking the adjusting angle of the adjusting bracket 9. Additionally, a protractor 33 is mounted on one side of the front portion of the adjusting bracket 9 for measuring an angle upon mounting the device for attaching the dental model to the articulator 32 and for checking positioning the device for attaching the dental model.

On the top surface of the adjusting bracket 9 there exist a line 34 placed on the same line as the incisive papillae intermediate point after fabricating the dental prosthesis, a line 35 placed on the same line as the bon will triangulation point placed at the front of 7 mm relative to the line 34, a line 36 indicating the cusp of canine teeth and the cusps on a posterior line in an oblique direction with respect to the line 34 indicating the incisive papillae intermediate point, and a line 37 placed at the front of 10 mm relative to the incisive papillae.

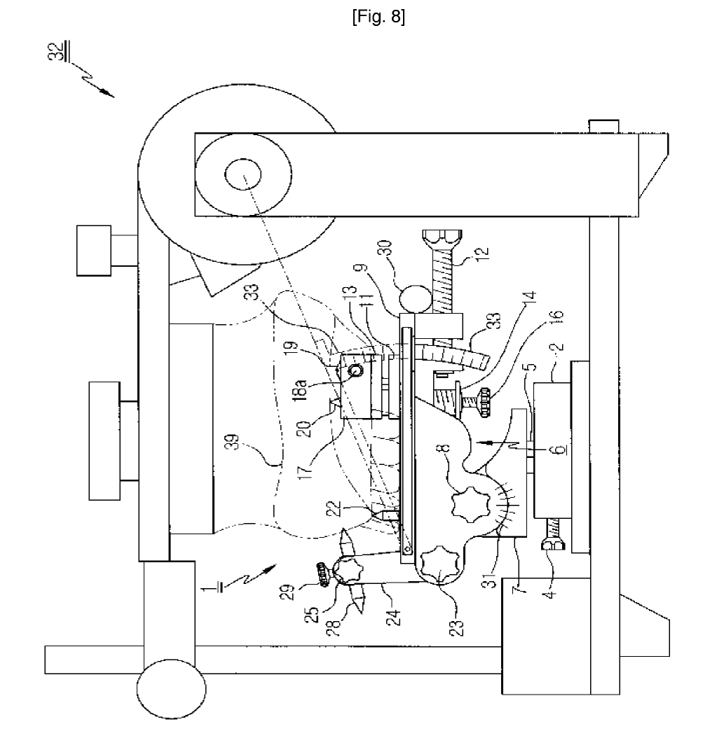

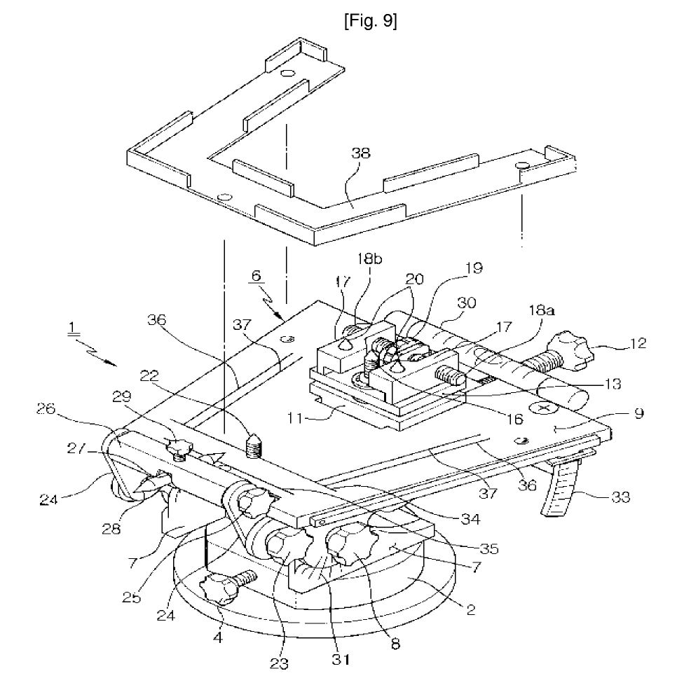

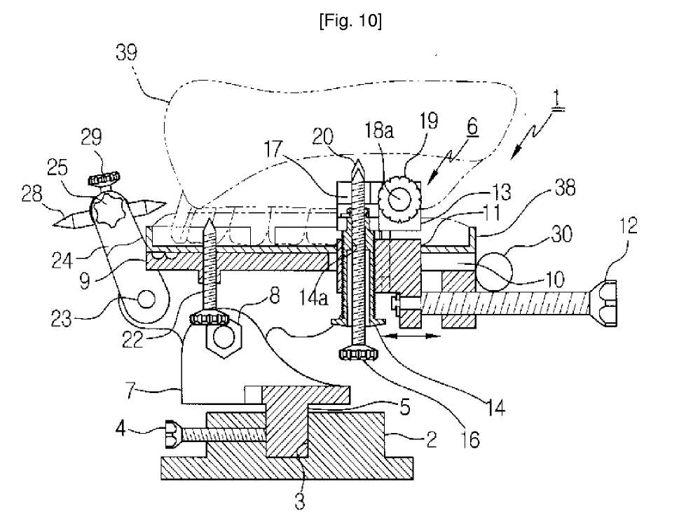

On the other hand, FIG. 8 shows an embodiment where a part is additionally mounted according to the present invention, wherein a plaster dental model mounting plate 38 is mounted on the top surface of the dental model attaching stand 6 of the device for attaching the dental model, on which a plaster dental model is fabricated to correct the errors generated when the registration on the dental model is conducted at a dental clinic after the fabrication of the dental model.

A reference numeral 39 in the drawings indicates the dental model.

The device 1 for attaching the dental model 39 to the articulator 32 is used during the fabrication of the dental prosthesis after an impression for a patient is conducted at the dental clinic to make the dental model 39 in a dental laboratory according to the patient's impression.

That is, the median sagittal plane components (upper labial frenum, incisive papillae, and median palatal raphe), which are appearing on the dental model 39 made on the basis of the patient's sagittal plane registered from the patient, are extended to a line that is generally □-shaped.

If it is assumed that the □-shaped extended line is the median sagittal plane, the dental model 39 is mounted on the dental model attaching stand 6 of the device 1 for attaching the dental model 39 of the present invention, as shown in FIG. 2. At this time, as the protractor 33 disposed on the dental model attaching stand 6 is adjusted, an angle in a range between 20° and 25° is formed between the dental model 39 and the articulator 32 as shown in an imaginary line of FIG. 8.

When the dental model 39 is mounted on the dental model attaching device 1 of this invention, the first ascending needle 16, the third ascending needle 22, and the fourth adjusting needle 28 to be positioned at the upper labial frenum of the anterior are placed in a linear line like the sagittal plane, and the two second ascending needles 20 that are placed at the front and back of the first ascending needle 16 have the same height as each other in such a manner as to be adjusted forwardly and backwardly.

The two second ascending needles 20 are placed at the front and back of the first ascending needle 16 as the adjusting knob 19 is rotated to adjust the forward and backward slider 17 in such a manner as to have the same forward or backward intervals from the median palatal raphe central line (in the drawings, the left and right sides relative to the real sagittal plane) by means of the left and right screws 18a and 18b, thereby finding the optimal forward and backward points having the same height in horizontal components.

In this case, if the errors between the sagittal plane of the dental model 39 and the sagittal plane observed from the patient's organism are generated, the first ascending needle 16 placed on the median palatal raphe is adjusted through the screw-type adjusting member 14 in such a manner as to be ascended by a given height, such that as the dental model 39 is inclined in left and right directions, the first and third ascending needles 16 and 22 and the fourth adjusting needle 28 on the top surface of the dental model attaching stand 6 are placed along the sagittal plane observed from the patient's organism, thereby correcting the errors between the sagittal plane of the dental model 39 and the sagittal plane observed from the patient's organism.

And, as the first ascending needle 16 and the second ascending needles 20 are mounted, on the upper and lower slider 13 connected above the screw-type adjusting member 14 coupled to the female hole 15 of the left and right slider 11, in such a manner as to be adjusted upwardly and downwardly at height thereof, they can be easily adjusted at height to match the height of the posterior by means of the screw adjustment of the screw-type adjusting member 14. The left and right slider 11 is slid in left and right sides by means of the left and right adjusting bolt 12 on the dental model attaching stand 6 in such a manner as to be easily adjusted on the median palatal raphe, and the second ascending needles 20 are mounted at the optimal left and right points having the same height at the front and back of the first ascending needle 16, such that the sagittal plane components and the left and right point components having the same height appearing on the dental model 39 can be found to match the sagittal plane really observed from the patient's organism.

On the other hand, on the basis of the theory where the bon will triangulation points comprise left and right condyles and the incisal edge (median mesial angle point; incisor point) of the mandibular central incisor of the anterior and the incisal edge (median mesial angle point; incisor point) of the maxillary central incisor is the end of the triangulation points, the incisive papilla intermediate point placed at the back by 7 mm as a mean length are set as a reference point at which the dental model 39 is placed, such that the upward and downward heights of the first ascending needle 16 are adjusted through the screw type adjustment at a time of setting the height of the anterior.

And, as the fourth adjusting needle 28 is placed along the sagittal plane appearing on the dental model 39, it functions to find the median sagittal plane components and the left and right side points having the same height relative to the median sagittal plane, while maintaining the one linear relationship with respect to the first ascending needle 16 and the third ascending needle 22. Thereby, the fourth adjusting needle 28 serves as an important part when the respective needles are placed on the dental model 39 along the sagittal plane observed from the patient's organism.

The fourth adjusting needle 28 is formed on the adjusting piece 26 that is adjusted an angle by means of the adjusting shaft pin 25 formed on the other end portion of the adjusting bracket 24 mounted by the adjusting shaft pin 23 on the adjusting bracket 9 of the dental model attaching stand 6, in such a manner as to be fixedly mounted by means of the a fixing bolt 29 on the adjusting piece 26, thereby allowing the adjustment thereof to be made in every direction.

As the sagittal plane line on the dental model 39 and the vertical line on the level 30 mounted at one side of the dental model attaching stand 6 conform with each other, the sagittal plane components according the earth gravity of the human body and the level 30 can be analyzed and observed.

### INDUSTRIAL APPLICABILITY

As described above, according to the device 1 for attaching a dental model to an articulator, respective needles are placed at the median sagittal plane components and the left and right side points having the same height relative to the median sagittal plane appearing on the dental model 39, and after that, the heights of the anterior and posterior are set to mount the maxillary dental model to the articulator 32, wherein the dental model is placed at the optimal functional position on the articulator 32 to obtain the reproduction of upper and down teeth occlusion motions. Accordingly, the device of this invention solves the problems that the complicate processes and the limits in the applicable range thereof the existing systems such as a shilla system, a face bow, a nano system, and B,P,S system have had.

More particularly, when compared with the existing systems having some limits in the reproduction of the oral motions relative to a patient's organism, the device of this invention can mount the dental model at the articulator in a range for reproducing fatigue oral motions by finding the sagittal plane of the patient's organism and the left and right side points having the same height relative to the patient's sagittal plane, thereby helping the fabrication of the dental prosthesis inclusive of clinical treatment planning according to the extrusion and intrusion causes, the reasonable articulation re-construction in a dental laboratory process, and artificial teeth arrangements.

1. A device (1) for attaching a dental model to an articulator (32), the device comprising:
a base frame (2) having an ascending hole (3) formed in the middle portion thereof such that the device (1) for attaching the dental model is adjusted upwardly and downwardly at height through the ascending hole (3);
a dental model attaching stand (6) having a fixed bracket (7) fixedly formed at the bottom portion thereof, the fixed bracket (7) having an ascending protrusion (5) formed at the bottom surface thereof in such a manner as to be adjusted at height by means of an adjusting bolt (4) formed on one side of the base frame (2), and having an adjusting bracket (9) formed on the fixed bracket (7) in such a manner as to be adjusted at angle by means of a screw-type adjusting shaft pin (8), the adjusting bracket having a sliding opening (10) formed on one side thereof;
a left and right slider (11) adapted to be guided through guide grooves (11a) thereof to the sliding opening (10) in such a manner as to be adjusted in left and right sides by means of an adjusting bolt (12) screw-coupled to the adjusting bracket (9);
an upper and lower slider (13) connected to the top side of a screw-type adjusting member (14) coupled to a female screw hole (15) formed on the left and right slider (11);
a first ascending needle (16) coupled to a female screw hole (14a) formed on the screw-type adjusting member (14) in such a manner as to be adjusted upwardly and downwardly at height thereof;
a plurality of forward and backward sliders (17) formed on both sides of the upper and lower slider (13) and coupled on both ends of a forward and backward adjusting screw portion (18) having left and right screws (18a and 18b) and an adjusting knob (19) thereon in such a manner as to be adjusted in forward and backward directions thereof;
a second ascending needle (20) fixed on the forward and backward sliders (17), respectively;
a third ascending needle (22) screw-coupled to a female screw hole (21) formed on the other side of the adjusting bracket (9) in such a manner as to be adjusted at height thereof;
an adjusting bracket (24) formed at the end portion of one side of the adjusting bracket (9) in such a manner as to be adjusted at angle by means of an adjusting shaft pin (23);
an adjusting piece (26) formed at the top end of the adjusting bracket (24) in such a manner as to be adjusted at angle by means of an adjusting shaft pin (25);
a fourth adjusting needle (28) coupled to an adjusting hole (27) formed on the adjusting piece (26) in such a manner as to be fixed by means of a fixing bolt (29);
a level (30) mounted on one side of the adjusting bracket (9);
a first protractor (33) mounted on one side of the adjusting bracket (9) for measuring an angle upon mounting the device for attaching the dental model to the articulator (32); and
a second protractor (31) mounted at a rotary portion of the adjusting shaft pin (8) with respect to the adjusting bracket (9).

2. The device according to claim 1, wherein a plaster dental model mounting plate (38) is mounted on the top surface of the adjusting bracket (9) constituting the dental model attaching stand (6).
